(19) United States
(12) Patent Application Publication
(10) Pub. No.: US 2012/0041990 A1
(43) Pub. Date: Feb. 16, 2012

(54) System and Method for Generating Dashboard Display in Software Applications

(75) Inventors: Olga Kreindlina, Heidelberg (DE); Hans-Ulrich von Helmolt, Heidelberg (DE)

(73) Assignee: SAP AG

(21) Appl. No.: 12/854,138

(22) Filed: Aug. 10, 2010

(51) Int. Cl. G06F 17/30

(52) U.S. Cl. 707/805; 707/E17.005

(57) ABSTRACT

Embodiments relate to a computer-implemented methods that include accessing one or more data fields within a file, the file having been configured using an external connection interface. The method includes mapping on a display computer system the accessed one or more data fields to data from one or more data sources, the mapping being performed based on user input via a graphical user interface. The embodiments may include displaying on the display computer system a dashboard according to a configuration in the file, the dashboard shows a graphical representation of the data from the one or more data sources and information from the one or more data fields.

### BACKGROUND

Database software can retrieve a vast quantity of data, however, the database software may lack the ability to display the data in an interactive graphical display. A developer may write software to generate a graphical display using the data from the database, however, writing customized graphic software can be time consuming and may involve programming expertise. A customized software may be used to generate the graphical display with controls that interact with the graphic display.

### SUMMARY

Embodiments relate to a computer-implemented method implemented on a non-transitory media that includes accessing one or more interface fields within an interactive graphic file, the file having been configured using an external connection interface. The method includes mapping on a display computer system the accessed one or more interface fields to data from one or more data sources, the mapping being performed based on user input via a graphical user interface. The embodiments include displaying on the display computer system a dashboard according to a configuration in the file, the dashboard shows an interactive graphical representation of the data from the one or more data sources.

Another embodiment may include, a computer-implemented method stored on computer readable media (i.e. one or more medium) for integrating visualization software with a data processing application to generate a dashboard. The configuration having been performed using a dashboard design system. This embodiment may include providing, using an external connection adapter, access to the one or more external interface first data ranges that may be configured to be displayed in the dashboard display and exporting the dashboard display to a graphic file format. Additionally or alternatively, embodiments may include accessing the one or more first data ranges from the dashboard display using a display computing system, connecting the one or more first data ranges to one or more second data ranges from one or more data sources, and displaying the dashboard display using data from the one or more second data ranges.

Another embodiment includes a user interface system that includes, an external connection adapter configured to access to one or more data fields within a file, a display computer system configured to map using a graphical user interface, the one or more data fields to data from one or more data sources and the display computer system configured to generate a dashboard display from a configuration in the file, the display including the data from one or more data sources and information from the one or more data fields.

### BRIEF DESCRIPTION OF THE DRAWINGS

FIG. 1 is a schematic diagram of a processing system according to an embodiment.

FIG. 2 is an example process that may be implemented using the systems shown in FIG. 1.

FIG. 3 is an example software architecture diagram that may be implemented using the systems shown in FIG. 1.

FIG. 4 is a screen display of a dashboard display system that may be used to configure a dashboard.

FIG. 5 is a screen display of the dashboard external interface screen that may allow another software program to transmit data in the data range.

FIG. 6 is a screen display that allows a user to choose a chart view in order to display data in a graphical format.

FIG. 7 is an example screen display showing the data mapping feature of the dashboard configuration screen.

FIG. 8 is an example screen display showing the graphical display of the data using the dashboard configuration shown in FIGS. 4-7.

### DETAILED DESCRIPTION OF EXAMPLE EMBODIMENTS

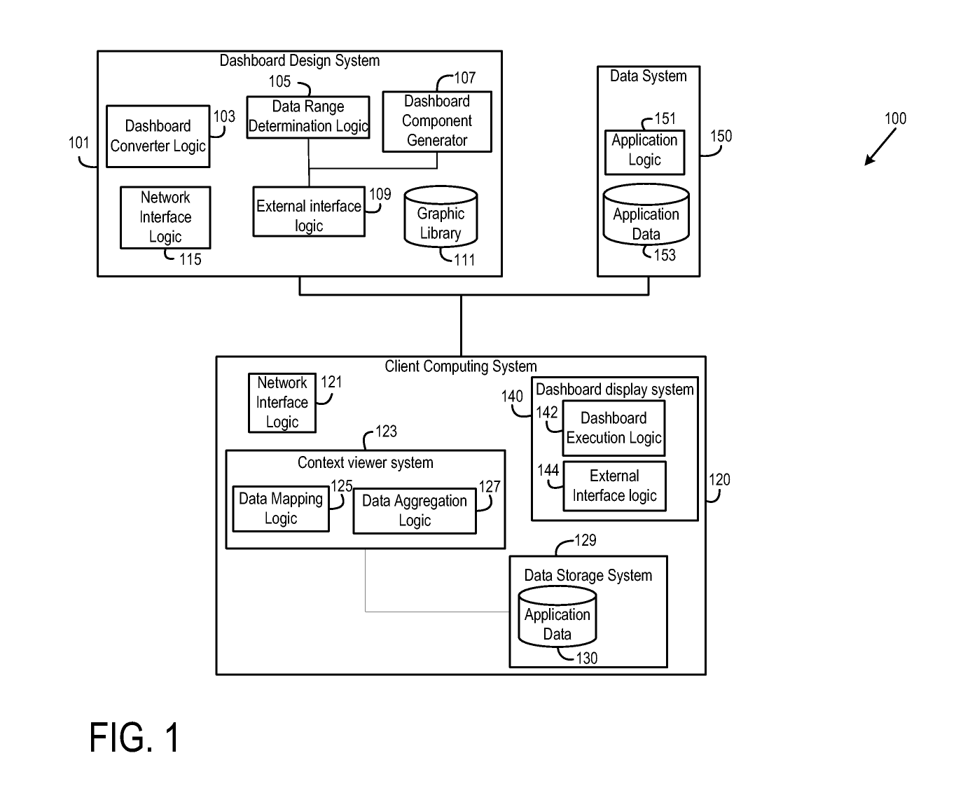

Referring to FIG. 1, FIG. 1 shows a schematic diagram of a system 100 according to an example embodiment. The system 100 may include a dashboard design system 101, which may be used during the dashboard configuration, display computer system 120, and data system 150. In an example embodiment, the dashboard design system 101 and the display computer system 120 may be a single computing system or several computing systems that may be connected via a network. Similarly, in another example embodiment, the display computer system 120 and data system 150 may be implemented on a single computing system or several computing systems that may be connected via a network.

The system 100 shown in FIG. 1 may be configured to perform runtime data integration with visually interactive dashboard display that may be configured to use a variety of enterprise resource data sources. Example dashboard program tools may include, Xcelsius®, BSC Designer Online®, Balanced scorecard Designer®, Transpara Visual KPI®, Software, iDashboard®, IBM Cognos®, Business Object Dashboard Builder® and so on. The system 100 allows a user to generate generic data connectivity without the user having to write programming code, while using a graphical user interface. Embodiments may allow the user in a business context viewer or other data applications to access the interaction and visualization features of a dashboard tool. In other embodiments, multiple queries (e.g. different systems or different data sources) may be accessed to create a visual display of one or more dashboard tools.

The dashboard design system 101 may include, among other systems, dashboard converter logic 103, data range determination logic 105, dashboard component generator 107, external interface logic 109, graphic library 111, and network interface logic 115. The dashboard design system 101 may include data processing computing systems, for example, comprising one or more networked computers that are programmed to perform the operations described herein. These operations include computing and/or communicating with the display computer system 120. In another embodiment, computing or communicating may include receiving requests, processing the requests, sending an appropriate response to the data system 150, updating the data storage system 105, and generating a dashboard file using dashboard converter logic 103. As discussed in greater detail herein, a dashboard may show a graphical display of data, such as but not limited to, a one or more charts, graphs and so on. The display may be shown with or without interactive controls to modify data values that may modify the displayed components.

In an example embodiment, the dashboard design system 101 and the display computer system 120 may be configured by one or more software companies. In another embodiment the display computer system 120 may be a single computer system or a virtual computer system that may include multiple application systems. In another embodiment, the dashboard design system 101 and the display computer system 120 may be provided by an entity that uses software provided by one or more software companies. Other combinations such as, the dashboard design system 101 may be provided by one company and the display computer system 120 may be provided by another company. The display computer system 120 may comprise various application logics and assemble various programs to form one or more software programs that may be used by the dashboard design system 101 and the data system 150.

The embodiments may be utilized in a variety of ways. For example, a customer that owns a copy or has a license to use the dashboard software may generate a display that shows a chart or graph based on recently gathered data that resides in a data system 150 without writing new programming code. In another example, data replication may not be performed and data from various data sources may be displayed in a single dashboard. The user can view a dashboard with the most updated data. In another example, the data being shown in the graphical form may be current data that is stored in the data source. Various customized dashboards may be created and integrated into, for example, applications designed to provide better insight and visibility across organizations, improve operational efficiency and effectiveness, increase flexibility, or related applications that use the business context viewer, business suit applications, and so on. Customers or users can use the business list viewer to retrieve, organize, and aggregate application data and display the data using advanced visualization tools provided by the dashboard software such as, the dashboard tools mentioned above. The combination of customizable visualization and enhanced integration of the dashboard tool allows the business decision maker to benefit from insightful business analytics. The software company provider may create pre-programmed customized dashboards or templates using the dashboard software or templates.

In an example embodiment, the dashboard file converter logic 103 may convert application specific data structures and data, to be compatible with or match with dashboard provided external interface logic 109. The dashboard converter logic 103 allows business application structures that may be based on a high level programming language such as Java®, or other programming languages, to transfer and receive data from the dashboard external interface logic 109. In another example embodiment, the dashboard converter logic 103 may facilitate the communication between the graphical dashboard and the business application. The business application may be based on Java®, ABAP® (Advanced Business Application Programming), C++®, C#®, SQL®, or other high or low level programming languages. In another example embodiment, the dashboard design system 101 may use Adobe® Flash® or other graphic display technologies. In other embodiments, the dashboard design system 101 may use Flash Island or other visual display generation technologies to display the dashboard components and controls. In another embodiment, the dashboard design system 101 may generate a dashboard in various file formats. One such format may be a short web format (SWF). The SWF file format is a multimedia vector graphic file that may be displayed using a Flash® or Flash Island player. The use of the Flash® technology may be facilitated by the graphic library 111. The graphic library 111 may allow files to play as movies or generate visual displays of data. The library core may be a graphic renderer that is capable of being re-used in applications that play Flash files or Flash based dashboard files. In another embodiment, the file format may be HTML® based, such that the HTML® includes graphic display and interactive components, such as, HTML 5®, XML® or other formats.

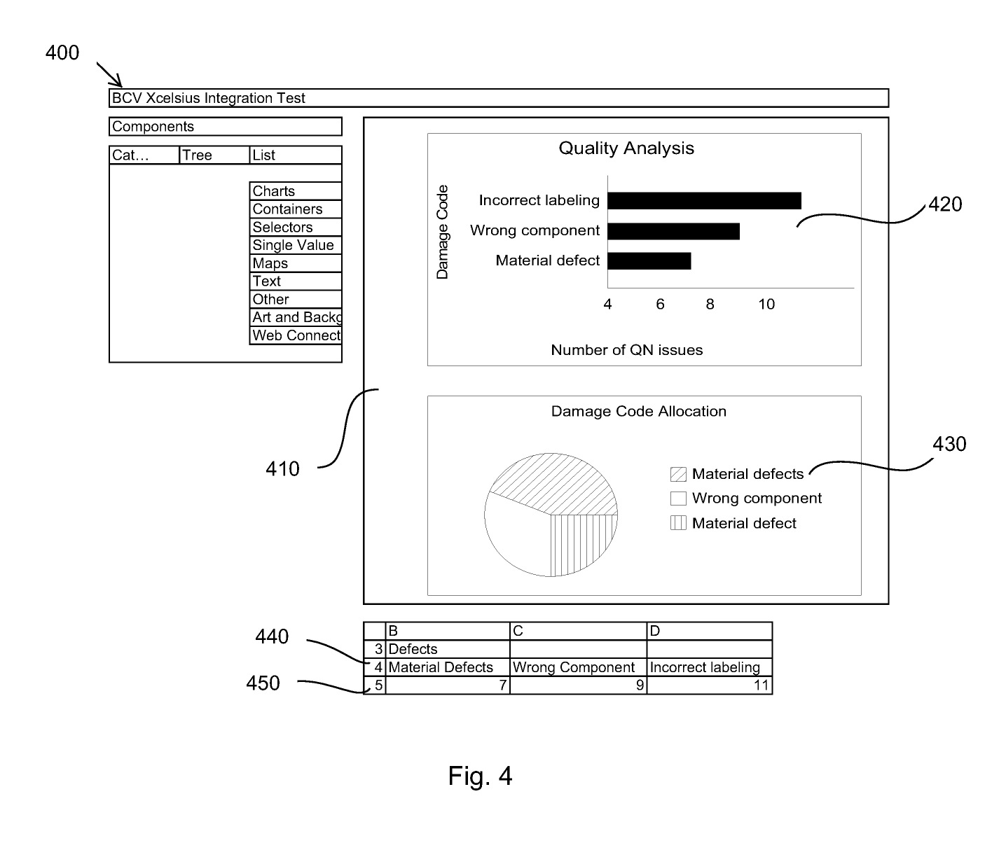

The data range determination logic 105, dashboard component generator 107 and the external interface logic 109 each may be used for designing the dashboard. Prior to displaying a dashboard in a business application, a dashboard or SWF file may be generated. The dashboard or SWF file may specify the data range, type of components and the external interface. The data range determination logic 105 may be configured to specify the data range in the spreadsheet associated with the dashboard file that may be used to generate a visual display. For example, the data range may include two or more components, and the user may choose a particular data range as defining the “labels” of the chart and the user may choose another data range for the “values” that are associated with the “labels.” For example, as shown in FIG. 4, the labels for the bar graph are located at data range B4 to D4. Also with regard to FIG. 4, the values for the labels are located at data range B5 to D5. Thus, the data range determination logic 105 may be configured to receive data ranges from a user or another software program.

Another embodiment may include a dashboard component generator 107 that may allow a user to place components with various attributes onto a canvas. The canvas may be a space where various visual components may be arranged. For example, the user may select a component from a component panel that includes a plurality of components and place them on the canvas in relation to other components. The components may be provided by the dashboard software provider or be add-ons from another software provider. The components may include various categories, such as, add-ons, art and background, charts, containers, selectors, single value, multi-value, maps, text, and web connectivity components. The chart components may include various types of charts, such as, bar graphs, pie charts, line graphs and so on, examples shown in FIGS. 4 and 9. Each component may be configured to receive input, such as, properties, attributes and data ranges that may be used to generate the interactive graphical display. Each component may have interactive abilities, for example, a wedge of a pie chart may be selected to display more data regarding the underlying data and the proportional percentage of the wedge. Other components such as single value components may be modified during runtime to visualize how a change in a single value affects other values. Multi-value components may also be used to visualize the effect of a change in multiple values.

Embodiments of an external interface logic 109 may allow a dashboard to expose selected data ranges associated with the dashboard display to a business software and related data sources. The access to the data ranges may create a framework that may be utilized by a graphical user interface to receive and send data into the dashboard or SWF file. The external interface logic 109 allows the business application software to export application data to be displayed in a dashboard in an interactive visual format.

Embodiments of a network interface logic 115 and 121 may connect the dashboard design system 101, display computer system 120 and data system 150 to each other, or to public networks. In one embodiment, network interface logic 115 and network interface logic 121 may be free from any communication during the execution of the dashboard or while the dashboard is being displayed. In this embodiment, the graphical file that has been configured by the computer system 101 may be stored in the data storage system 129. The graphic file may be used for data mapping (during configuration or design time) and for generating the graphical display during execution. The external adapter may facilitate the communication between data storage system 129 and the graphical file.

Alternatively or additionally, the network interface logics 115 and 121 may permit the computer systems 101, 120 and 150 to connect to each other and the other computer systems. For example, in the context of desktop/laptop computers, network interface logic 115 and 121 may comprise one or more computers or web servers that provide a graphical user interface for users that access the subsystems of system 101, 120 or 150 through the internet or an intranet protocol. Network interface logic 115, and 121 may also comprise other logics that may be configured to provide an interface for other types of devices such as mobile devices (e.g., cell phones, smart phones, and so on) and server-based computing systems.

In an example embodiment, the display computer system 120 may include, network interface logic 121, context viewer system 123, data storage system 129 and dashboard display system 140. In an alternative embodiment, the dashboard display system 140 may be included in the context viewer system 123. Such logics or systems may, in practice, be implemented in a machine (e.g., one or more display and other computers) comprising machine-readable storage media (i.e. cache, memory, flash drive or internal or external hard drive or in a cloud computing environment, non-transitory computer readable media or non-transmissible computer-readable media) having instructions stored therein which are executed by the machine to perform the operations described herein. The context viewer system 123 may be a program product that performs various processing functions such as receiving data from the data source, preparing data by aggregating and providing access to visualization capabilities, and so on. The data storage system 129 may store data related to the applications that are being executed or may be executed on the display computer system 120. In another embodiment, the data storage system 129 may store business application data or statistical data such as, business warehouse data. In an example embodiment, the dashboard display system 140 may be in communication with the display computer system 120 to display data in a dashboard in a visual manner or in visual components using graphics. Displaying data graphically may include displaying bar graphs and/or pie charts or other visual displays. In order to generate the dashboard display, the user may map dashboard data fields to the business application data fields. The mapping allows the dashboard tool to access data from the business applications without data replication. These features are discussed in greater detail below with reference to FIGS. 4-9.

Embodiments of the data storage system 129 may store a variety of information including application data in database 130. The application data database 130 may receive data from the data system 150. The data storage system 129 may provide data to the context viewer system 123. More specifically, the data storage system 129 may provide data to the data aggregation logic 127. The data storage system 129 may receive appropriate data mapping instructions from the data mapping logic 125 and query the data system 150 to correlate the data from one mapped field in the dashboard tool to the mapped fields in the application data 153.

Embodiments of the dashboard display system 140 may be provided on the display computer system 120. In an example embodiment, the dashboard display system 140 may transfer data from various data sources or data from various applications to external data ranges of the graphic file and display the graphical interface during runtime operations. The dashboard display system 140 may include all of the features discussed above with regard to the dashboard design system 101. Also, the dashboard display system 140 also includes a dashboard execution logic 142 and external interface logic 144. The external interface logic 144 may have similar features as the external interface logic 109 of the dashboard design system 101. The external interface logic 144 may expose selected data ranges of the dashboard to the business software data. The external interface logic 144 may allow the business application software to export application data to be displayed in the dashboard in a visual format instead of a textual format. During runtime when displaying the dashboard in the business application, the dashboard execution logic 142 is configured to receive the data from the business application and generate a Flash Island interactive display as designed by the dashboard design system 101 or dashboard display system 140.

The data system 150 includes an application logic 151 and application data 153. The data system 150 may be configured to provide data and communicate with the display computer system 120. The application logic 151 is the server side of the application that provides back end information to the context viewer system 123. For example, the application logic 151 may comprise an Enterprise Resource Planning (ERP), Customer Relation Management (CRM) or Business Intelligence (BI) system. Business intelligence may refer to computer-based techniques used to analyze business data, such as sales revenue by products and/or departments or associated costs and incomes. The application data 153 may include relational or other types of databases. The application data 153 includes various fields that may be mapped to the fields exposed by the external dashboard interface.

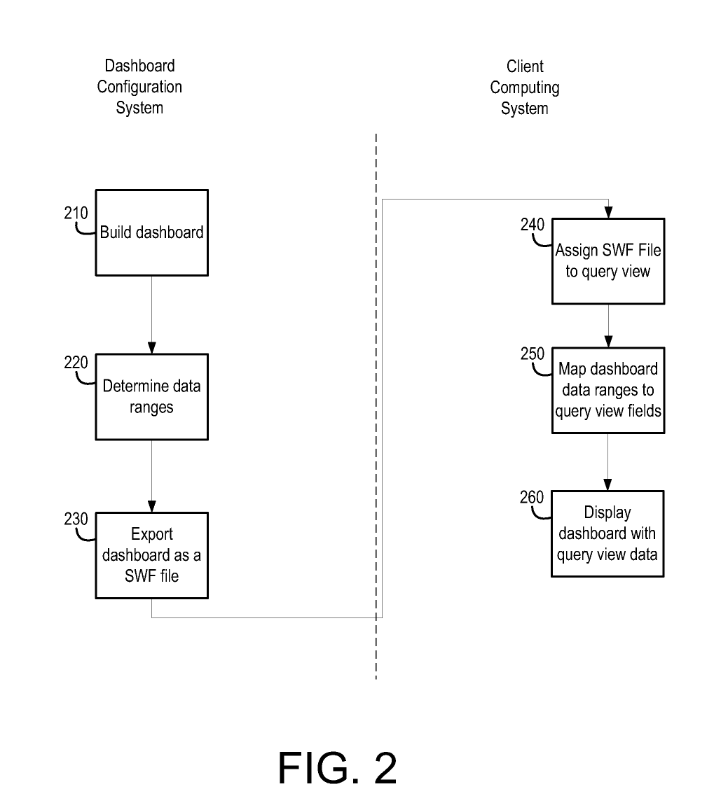

Referring to FIG. 2, FIG. 2 is an example process that may be implemented using the system shown in FIG. 1. Initially, at step 210, in an example embodiment a dashboard design user may build a dashboard using a dashboard building software. The dashboard design user may configure the dashboard during design time. In an example embodiment, design time may include the design user configuring the dashboard layout and exposing a related data range. The dashboard design system 101 may be used to create a dashboard layout. Building the dashboard includes placing components on the canvas and configuring the properties associated with those components. As discussed above, the components may be among other components, a chart or graph. At step 220, the dashboard design user may determine and specify using a graphical user interface the data ranges for the dashboard. After creating the dashboard, at step 230, the dashboard may be exported automatically or by input from the dashboard design user to a SWF file format. Steps 210, 220 and 230 may be performed by the dashboard design user using the dashboard configuration system 101.

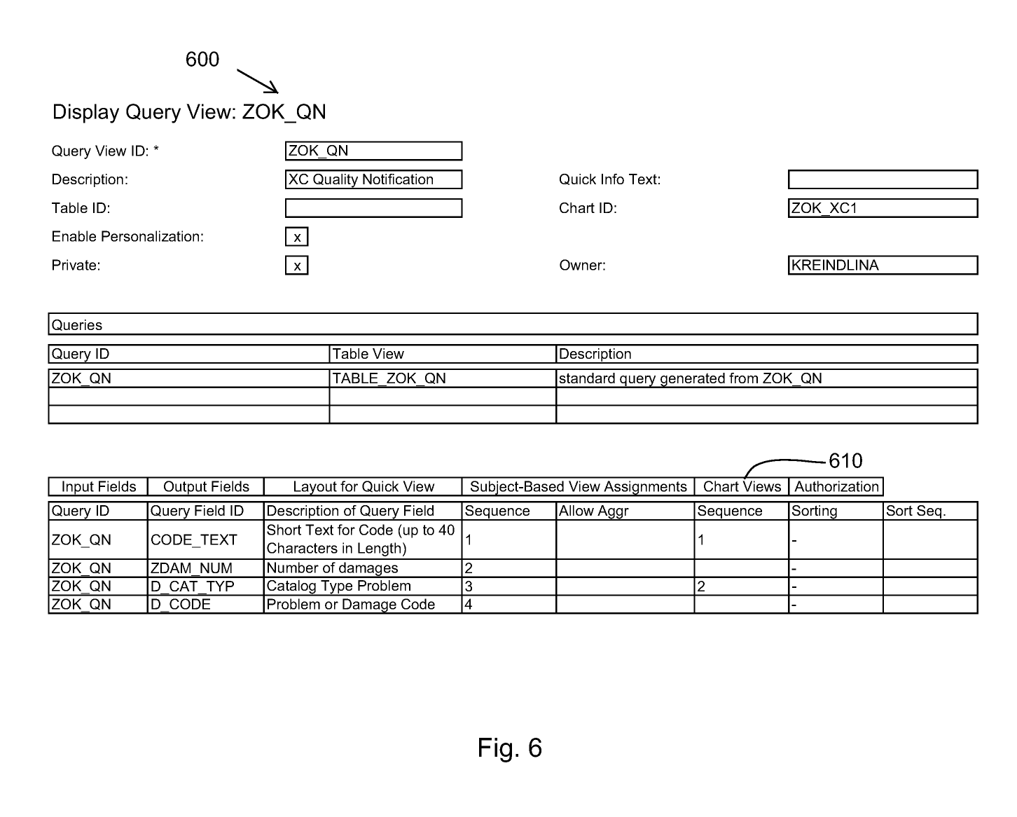

A business user may perform the other steps of FIG. 2 by using the display computer system 120. In an example embodiment, the business user's steps may be performed during runtime. In this embodiment, runtime includes displaying of the dashboard in a business application using data from business application data sources. In another embodiment, the business user may perform the steps described above with regard to the dashboard design user. At step 240, the business user may open the context viewer system where the business user may select a chart view 610 as shown in FIG. 6. In the chart view tab, the business user may assign the dashboard or SWF® file to a query view by specifying the location of the file. At step 250, the dashboard data ranges that were determined at step 220 may be mapped to query view fields. In an example embodiment, the data from the data source 129 (or 150) is placed in the mapped location in the dashboard. In another example embodiment, the mapping between application data and graphical interface data may identify which application data may be shown in the reserved placeholder of the dashboard. After mapping the data ranges, at step 260 the dashboard may be displayed in the business application. In one embodiment the business application may be software applications that provides various functionalities such as, customer relationship management, enterprise resource management, product lifecycle management, supply chain management and supplier relationship management. In another embodiment, the dashboard may be configured to receive data from the data system 150 after the mapping has occurred or the data may be accessed during runtime.

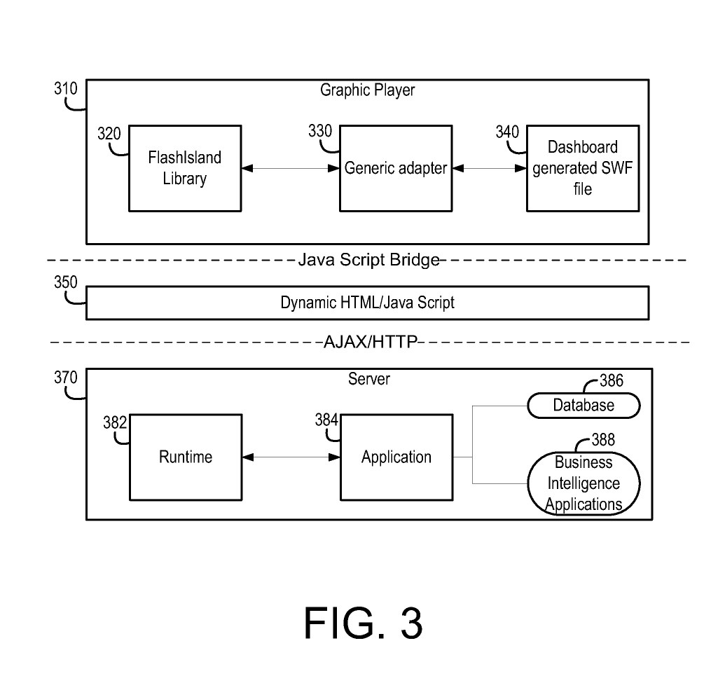

Referring to FIG. 3, FIG. 3 is an example software architecture that may be implemented using the system in FIG. 1. The software architecture diagram shown in FIG. 3, shows various software layers, such as, graphic player 310, component Dynamic HTML or Java® Script 350, and Server (Java® or Java® based or other high level programming language based) 370 layers. In particular, the generic adapter 330 may be built with the Flash Island library, which may facilitate the client-side communication between HTML and JavaScript®. The Dynamic HTML 350 may load the generated dashboard in a graphic file, or Flash/SWF representation. The generic adapter 330 may convert the Java® context into structures that match the dashboard's external interface format or the dashboard format. The generic adapter 330 allows the business user to generate a dashboard in a business analytic software using the most updated data from a data source without writing any customized software. The generic adapter 330 may load dashboard data ranges and convert the associated data into an XML® string that may be used for further conversion into an ABAP® string, which may be used by the business analytic software.

In another embodiment, the generic adapter 330 may convert the Flash Island properties into dashboard structures. In an example embodiment, the generic adapter 330 may be used to load external dashboard ranges during the configuration stage, at step 250. In this embodiment, the generic adapter 330 may push application data to the data ranges defined in step 250. In another embodiment, the generic adapter 330 may provide an application programming interface between the graphic player 310 and the server 370. The generic adapter 330 may load dashboard ranges automatically and the dashboard data ranges may be converted into XML strings. The XML string may be converted into Java® or ABAP® code which may be executed by the business application 384, to display a dashboard. The server 370 may include NetWeaver®, ABAP® or Java® language programming and the server may include various systems that are supported in the business software suit, the runtime 382, application 384, database 386 and business intelligence application 388. In another embodiment, the functionality of the server 370 may be implemented by the display computing system 120. In yet another embodiment the functionality of server 370 may be divided between the display computing system 120 and data system 150. In another embodiment, the graphic player 310 may be implemented on the dashboard design system 101. Additionally or alternatively, the functionality of the graphic player 310 may be implemented on the display computing system 120.

Referring to FIG. 4, FIG. 4 shows a screen display 400 of the dashboard designer that may be used to design a dashboard display according to the system shown in FIG. 1. The dashboard designer may be executed by the dashboard design system 101. The dashboard may be created on the canvas 410. A dashboard design user may place the components from the component panel on the canvas 410. As shown in FIG. 4, the canvas 410 has a bar graph 420 and a pie chart 430 that are displayed in this example dashboard. The dashboard 400 shown in FIG. 4 is using example data from the spreadsheet shown at the bottom of FIG. 4. For example, the labels of the bar graph “Incorrect labeling”, “Wrong component” and “Material defects” are from the spreadsheet shown below. In particular, the cell range from B4 to D5 440 was selected as input into the properties of the bar graph and the pie chart. Next, the data in the bar graph and the pie chart is received from cell range B5 to D5. In order to generate this dashboard the dashboard design user may associate various data fields with particular component properties.

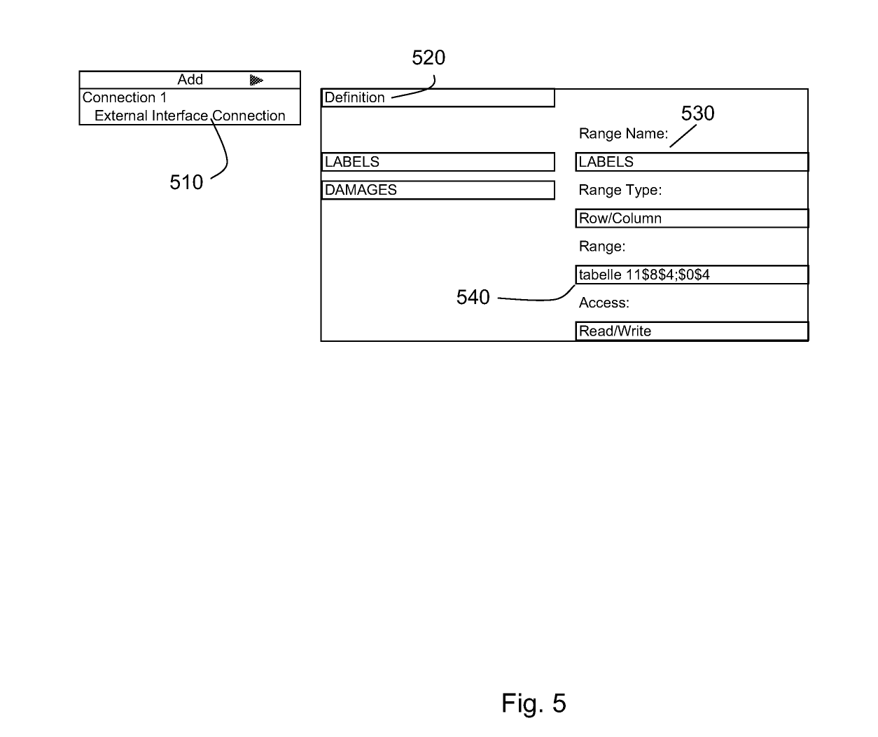

Referring to FIG. 5, FIG. 5 is a screen display of the dashboard external interface that can permit another software program to access the dashboard controls and display. The external interface connection 510 may allow data from the application system to be passed to a cell range of the dashboard or SWF file, using push technology. During the execution of the dashboard or runtime, data may be pushed or sent from the data source, based on the mapping, to the dashboard. In this embodiment, the data may be transferred in tabular form across an interface. In another embodiment the external interface connection 510 may allow the use of pull technology, where the data is pulled by the context viewer system 123. In another embodiment, during the configuration of the dashboard when the “Generate XC Fields” button is clicked, the defined data rangeswill be pulled to the system 144, for example in FIG. 5. The external interface connection 510 may be configured using a definition tab 520, range name 530, range type, range 540 and access type properties. External interface connections allow a dashboard design user to expose selected data ranges relating to the dashboard display. The range name 530 in FIG. 5 is shown as Labels and the range 540 being assigned, “Table 1!$B$4:$D$4” which is the cell range from B4 to D4. In this example embodiment, the labels from B4 to D4 will be used for mapping the Labels field. After specifying the data range, the dashboard design user may export the dashboard as a file, the file may be executed by various software program including business software.

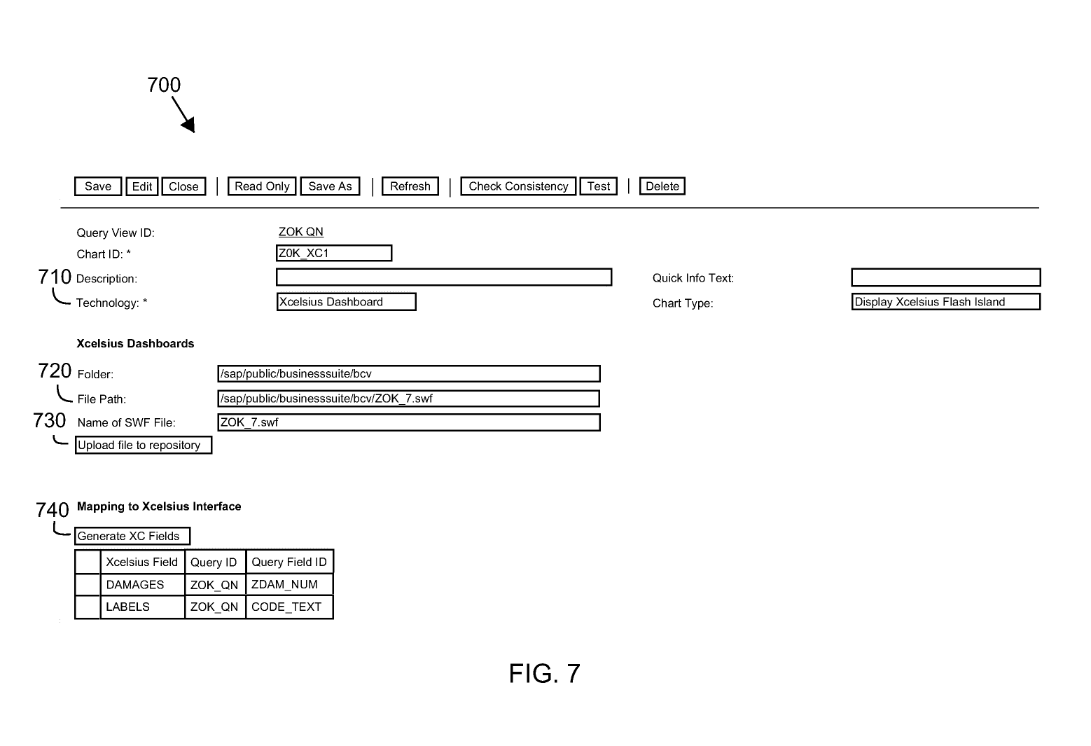

Referring to FIG. 6, FIG. 6 is a screen display that allows a user to choose a chart view in order to display a dashboard. In particular, the query view 600 is part of the context viewer application and includes various data types from a business analytics database. If the user chooses to view a chart, the user may select the chart view 610. After a user selects the chart view 610 then the user may be presented with a screen shown in FIG. 7.

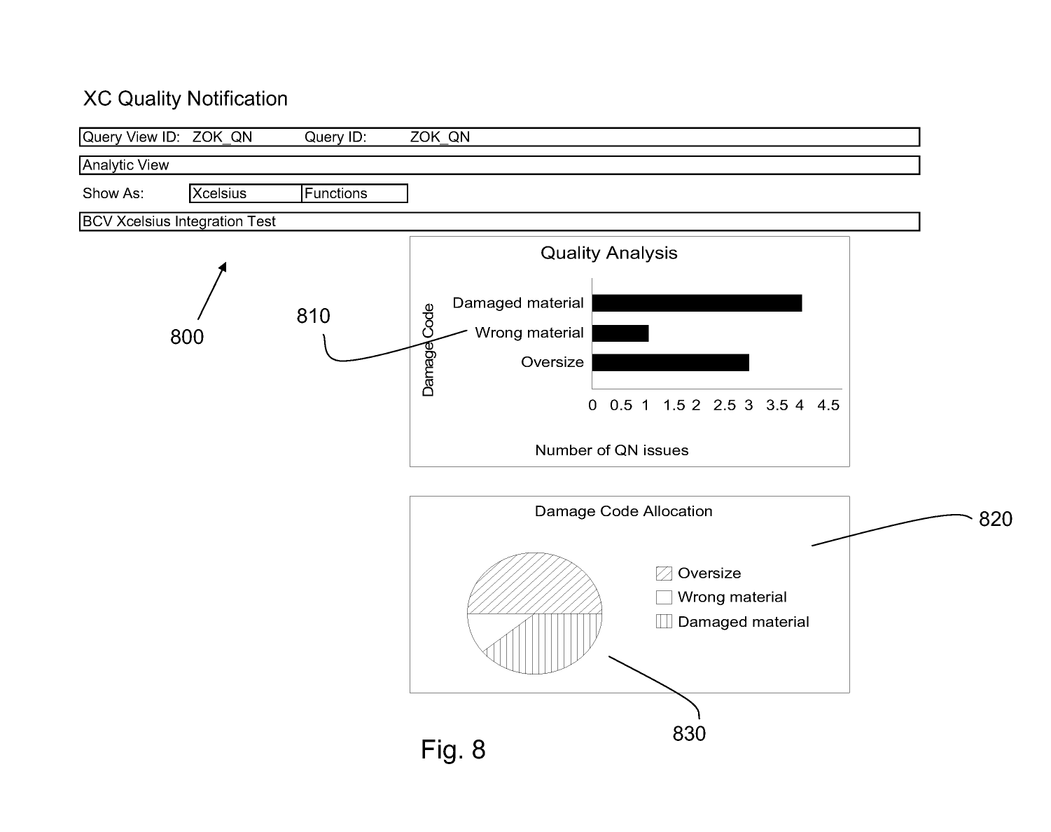

Referring to FIG. 7, FIG. 7 is an example screen display showing the data mapping for the dashboard configuration screen. Screen 700 shows a user interface where the user may select (using a pull down menu) the type of technology 710 the user plans to use for the chart view display. Here, the user may select the type of dashboard file that was created as the technology. Next, the file path 720 of the exported dashboard or SWF file may be specified. After choosing a SWF file, the user may select the “Upload file to repository” button 730 in order to save a graphic file (SWF file) in the system 123. After selecting button 740 “Generate XC Fields”, may be the name of the dashboard external data ranges (e.g. “Damages” and “Labels” in FIG. 5). In the mapping shown in FIG. 7, the user may enter or browse for the name of data source (Query ID). For example, the Query ID shown in this example is “ZOK_QN”. This entry is mapped against the data source that may be stored in the application data 153. The user may search for the Query Field ID, which is a specific field of data source Query ID (e.g. field “CODE TEXT” of Query ID “ZOK_QN” in the provided example). Creating this mapping allows the dashboard to utilize the data in the application data 153 or 130. As can be appreciated that programming in a textual or visual manner is not required and the user may create the dashboard, export the dashboard, map the fields and display the dashboard as shown in FIG. 8 using a graphical user interface that responds to a pointing device (e.g. mouse, pen or display device that is sensitive to touch or ocular movement).

Referring to FIG. 8, FIG. 8 is an example screen display showing the graphical display of the data using the dashboard configuration from FIGS. 4-7. FIG. 8 shows a dashboard 800 that includes the bar graph 810 and pie chart 820. The labels and the value data in the bar and the pie charts 810 and 820 are from the business software and are different than the data used in FIG. 4. Therefore, the user can create a display of a dashboard in another application by using an external connection that may expose data fields to permit the visualization of any type of data.

The embodiments refer to a dashboard that may be a web-based or other technology based display on which real time data is collated, processed and displayed from multiple data sources that belong to one or more businesses. Other terms that may be used to describe a dashboard, include, digital dashboard, enterprise dashboard, business dashboard, executive dashboard, operational dashboard, BI dashboard, database dashboard, Web dashboard, performance dashboard, score card, KPI dashboard, metrics dashboard and so on. Dashboards may be designed to help any user monitor what's happening or has happened in the past visually or at a glance. Dashboards may provide the user a means to rapidly monitor the current status. Accordingly, dashboards must be designed to take advantage of the strengths of visual perception, cognition and work around or augment the users weaknesses.

Embodiments may include a system for displaying data stored on computer readable non-transitory media. The system configured to access one or more data fields within a file. The file having been configured using an external connection adapter. The system may include a display computer system configured to map the accessed one or more data fields to data from one or more data sources, the mapping being performed based on a user input via a graphical user interface. In this embodiment, the system may be configured to display on the display computer system a dashboard according to the configuration setting stored in the file, the dashboard may show a graphical representation of the data from the one or more data sources and information from the one or more data fields.

In another embodiment, the dashboard further comprising dashboard display system that processes the data from the one or more data sources and displays a visual representation of the data in a graph or chart form. Alternatively or additionally, the dashboard includes a component that may be modified by using a graphical user interface such that the dashboard display or components are modified.

In another embodiment, the file is generated by a first software program located in the dashboard design system that is configured to generate the dashboard. The display computing system may further comprise executing a second software program on the display computer system to retrieve the data from the one or more data sources and displaying the dashboard. The display computing system may include converting, using a generic adapter, the data from the one or more data sources into data structures that are compatible with a format of the graphic file.

Another embodiment may include converting the data from the one or more data sources into data structures that are compatible with a format of the file using the external connection adapter. Additionally or alternatively, the file may be a short web format file that exposes one or more data fields that may be mapped to fields in one or more data sources. In another embodiment, the mapping may occur via a graphical user interface free of receiving textual programming code from the user.

Another embodiment may include a computer-implemented method stored on a computer readable media. The method may include integrating visualization software with a data processing application that includes configuring a dashboard display using a dashboard design system, the dashboard display configured to use one or more first data ranges from a spreadsheet as example data. This embodiment may include using an external connection adapter to provide access to one or more first data ranges that are to be displayed in the dashboard display. Embodiments may include exporting the dashboard display in a graphic file format. Additionally or alternative embodiments may include accessing one or more first data ranges from the dashboard display using a display computing system. Various embodiments may include connecting one or more first data ranges to one or more second data ranges from one or more data sources. In addition this embodiment may include displaying the dashboard display using data from the one or more second data ranges.

The method may include connecting the dashboard display with the data using a graphical user interface that is free from receiving textual or textual programming code from the user. In this embodiment the method may include processing data from the one or more data sources and displaying a visual representation of the data in a graph or chart form. This embodiment may include a method that includes a component that may be modified by using a graphical user interface that results in a modification of the dashboard display. Another embodiment of the method may include a dashboard display generated by a first software program that is configured to generate a visual display. The embodiment may include executing a second software program on the display computer system to retrieve the data from the one or more data sources and displaying the dashboard and the method may include converting, using a generic adapter, the data from the one or more data sources into data structures that are compatible with a format of the file.

The exporting in this embodiment may include converting the data from the one or more second data sources into data structures that are compatible with the graphic file format. The method may include the converting being performed by an external interface adapter. Additionally the method may include the graphic file format being a short web format that allows a software to access the one or more first data ranges.

Another embodiment may include a user interface system that has an external connection adapter configured to provide access to one or more data fields within a file. This embodiment may include a display computer system configured to map using a graphical user interface the one or more data fields to data from one or more data sources. The display computer system may be configured to generate a dashboard display from a configuration in the file, the display may include the data from one or more data sources and information from one or more data fields. This embodiment may include a graphical user interface that is free of receiving textual programming code from the user.

Another embodiment may include a first software executed on a display computer system that is configured to generate the dashboard in a visual graphic display. This embodiment may include a second software program configured to execute on the display computer system to retrieve the data from the one or more data sources and display the dashboard display. This embodiment may include a generic adapter configured to convert the data from the one or more data sources into one or more data structures that are compatible with a format of the file. Another embodiment may include a component that is configured to be modified by a graphical user interface that results in modifying the dashboard display. In yet another embodiment an external connection adapter may be configured to convert the data from the one or more data sources into data structures that are compatible with a format of the file using the external connection adapter.

Embodiments refer to a user of a graphical user interface, which is a type of interface that allows users to interact with software programs in more ways than typing with hardware that displays images rather than text commands. A graphical user interface may offer graphical icons, and visual indicators, as opposed to text based interface. Many users prefer to use a graphical user interface instead of typing textual commands or programming code. Various programming software that are known as integrated development environments (IDE) may offer a graphical visual interface to develop programs. For example IDEs such as, Visual Studio, Delphi®, C++ Builder, EffelStudio, Xcode, Eclipse, NetBeans, and so on. Embodiments are not directed to graphical user interface software environments. The embodiments are directed to displaying a dashboard from one software application using another software application where both software applications are not software development applications.

The embodiments have been described with reference to drawings. The drawings illustrate certain details of specific embodiments that may be implemented by the systems and methods of the embodiments described above. However, describing the embodiments with drawings should not be construed as imposing any limitations that may be present in the drawings. The present embodiments contemplate methods, systems and program products on any non-transitory machine-readable media for accomplishing its operations. The embodiments may be implemented using an existing computer processor, or by a special purpose computer processor incorporated for this or another purpose or by a hardwired system.

As noted above, embodiments include program products or logics comprising machine-readable media for carrying or having machine-executable instructions or data structures stored thereon. Such machine-readable media may be any available media that may be accessed by a general purpose or special purpose computer or other machine with a processor. By way of example, such machine-readable media may comprise RAM, ROM, EPROM, EEPROM, CD-ROM or other optical disk storage, magnetic disk storage or other magnetic storage devices, non-transitory computer readable media or non-transmissible computer-readable media or any other medium which may be used to carry or store desired program code in the form of machine-executable instructions or data structures and which may be accessed by a general purpose or special purpose computer or other machine with a processor. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the embodiments might include a general purpose computing computers in the form of computers, including a processing unit, a system memory or database, and a system bus that couples various system components including the system memory to the processing unit. The database or system memory may include read only memory (ROM) and random access memory (RAM). The database may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. User interfaces, as described herein may include a computer with monitor, keyboard, a keypad, a mouse, joystick or other input devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present embodiments. Such variations will depend on the software and hardware systems chosen and on designer choice. It is understood that all such variations are within the scope of the embodiments. Likewise, software and web implementations of the present embodiments could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the embodiments to the precise form disclosed, and modifications and variations are possible in light of the above teachings or may be acquired from practice of the embodiments. The embodiments were chosen and described in order to explain the principals and practical application to enable one skilled in the art to utilize the embodiments with various modifications as are suited to the particular use contemplated. Other substitutions, modifications, changes and omissions may be made in the design, operating conditions and arrangement of the embodiments without departing from the scope of the present embodiments.

Throughout the specification, numerous advantages of the exemplary embodiments have been identified. It will be understood of course that it is possible to employ the teachings herein without necessarily achieving the same advantages. Additionally, although many features have been described in the context of a particular data processing unit, it will be appreciated that such features could also be implemented in the context of other hardware configurations.

While the exemplary embodiments illustrated in the figures and described above are presently preferred, it should be understood that these embodiments are offered by way of example only. Other embodiments may include, for example, structures with different data mapping or different data. The embodiments not limited to a particular embodiment, but extends to various modifications, combinations, and permutations that nevertheless fall within the scope and spirit of the appended claims.

What is claimed is:

1. A computer-implemented method stored on computer readable non-transitory media, comprising:
accessing one or more data fields within a file;
mapping on a display computer system the accessed one or more data fields to data from one or more data sources, the mapping being performed based on a user input via a graphical user interface; and
displaying on the display computer system a dashboard according to a configuration in the file, the dashboard shows a graphical representation of the data from the one or more data sources and information from the one or more data fields.

2. The method of claim 1, wherein the dashboard processes the data from the one or more data sources and displays a visual representation of the data in a graph or chart form.

3. The method of claim 2, wherein the dashboard includes a component that may be modified by using a graphical user interface such that the dashboard is modified.

4. The method of claim 1,
wherein the file is generated by a first software program that is configured to generate the dashboard;
further comprising executing a second software program on the display computer system to retrieve the data from the one or more data sources and displaying the dashboard; and
further comprising converting, using a generic adapter, the data from the one or more data sources into data structures that are compatible with a format of the file.

5. The method of claim 1, further comprising converting the data from the one or more data sources into data structures that are compatible with a format of the file using the external connection adapter.

6. The method of claim 1, wherein the file is a short web format file that exposes the one or more data fields that may be mapped to fields in the one or more data sources.

7. The method of claim 1, wherein the mapping occurs via a graphical user interface free of receiving textual programming code from the user.

8. A computer-implemented method stored on computer readable non-transitory media, comprising:
accessing data from one or more data sources to retrieve data on a dashboard display system;
mapping using a dashboard display system the accessed data from one or more data sources, the mapping being performed using a graphical user interface;
displaying an interactive graphic dashboard using the accessed data according to the mapping.

9. The method of claim 8, wherein the mapping is performed via a graphical user interface that is free of receiving textual input.

10. The method of claim 8, wherein the dashboard display system processes the data from the one or more data sources and displays a visual representation of the data in a graph or chart form.

11. The method of claim 8, wherein the interactive graphic display includes a component that may be modified by using a graphical user interface that results in a modification of the dashboard display.

12. The method of claim 8,
wherein the interactive graphic display is generated by a first software program that is configured to generate a visual display;
further comprising executing a second software program on the display computer system to retrieve the data from the one or more data sources and displaying the dashboard; and
further comprising converting, using a generic adapter, the data from the one or more data sources into data structures that are compatible with the interactive graphic dashboard.

13. The method of claim 8, further comprising converting the data from the one or more second data sources into data structures that are compatible with the graphic file format.

14. The method of claim 13, wherein the converting is performed by an external interface adapter.

15. The method of claim 1, wherein the interactive graphic dashboard is stored in a short web format file that is configured to access one or more first data ranges from the data.

16. A user interface system comprising:
an external connection adapter configured to provide access to one or more data fields within a file;
a display computer system configured to map using a graphical user interface the one or more data fields to data from one or more data sources; and
the display computer system configured to generate a dashboard display from a configuration in the file, the display including the data from one or more data sources and information from the one or more data fields.

17. The system of claim 16, wherein the graphical user interface is free of receiving textual programming code from the user.

18. The system of claim 16,
further comprising a first software that is configured to generate the dashboard display that is configured to generate a visual display;
further comprising a second software program configured to execute on the display computer system to retrieve the data from the one or more data sources and display the dashboard display;
further comprising a generic adapter configured to convert the data from the one or more data sources into data structures that are compatible with a format of the file.

19. The system of claim 16, further comprising a component that may be modified by using a graphical user interface that results in a modification of the dashboard display.

20. The system of claim 16, further comprising an external connection adapter configured to convert the data from the one or more data sources into data structures that are compatible with a format of the file using the external connection adapter.
